(19) United States
(12) Patent Application Publication
(10) Pub. No.: US 2026/0330181 A1
(43) Pub. Date: Oct. 22, 2026

(54) System, Method, and Computer Program Product for Determining Influence of a Node of a Graph on a Graph Neural Network

(71) Applicant: Visa International Service Association, San Francisco, CA (US)

(72) Inventors: Zhimeng Jiang, College Station, TX (US); Huiyuan Chen, San Jose, CA (US); Han Xu, Lansing, MI (US); Menghai Pan, San Jose, CA (US); Xiaoting Li, Sunnyvale, CA (US); Mahashweta Das, Campbell, CA (US); Hao Yang, San Jose, CA (US)

(21) Appl. No.: 19/114,979

(22) PCT Filed: Sep. 27, 2023
(86) PCT No.: PCT/US2023/033802

§ 371 Date: Mar. 25, 2025

(51) Int. Cl. G06N 3/042; G06N 3/08

(52) U.S. Cl. CPC G06N 3/042; G06N 3/08

(57) ABSTRACT

Systems, methods, and computer program products are provided for determining influence of a node of a graph on a graph neural network (GNN). The method includes receiving a dataset including graph data associated with a graph. The method may further include selecting a target node of a plurality of nodes based on the graph data and determining target node data associated with the target node and target edge data associated with the target node. The method may further include removing the target node data and the target edge data from the dataset to provide a target graph dataset; determining a measure of influence of the target node on a GNN based on the target graph dataset, wherein the GNN was trained using the dataset; and performing an action based on the measure of influence of the target node on the GNN.

### CROSS-REFERENCE TO RELATED APPLICATIONS

This application is the United States national phase of International Application No. PCT/US23/33802, filed Sep. 27, 2023, and claims priority to U.S. Provisional Patent Application No. 63/410,553, filed on Sep. 27, 2022, the disclosures of which are hereby incorporated by reference in their entireties.

### BACKGROUND

### 1. Technical Field

This disclosure relates generally to graph neural networks (GNNs) and, in some non-limiting embodiments or aspects, to systems, methods, and computer program products for determining influence of a node of a graph on a GNN.

### 2. Technical Considerations

Some machine learning models, such as neural networks (e.g., a convolutional neural network), may receive an input dataset including data points for training. Each data point in the training dataset may have a different effect on a neural network (e.g., a trained neural network) generated based on training the neural network after the neural network is trained. In some instances, input datasets (e.g., training datasets) designed for neural networks may be independent and identically distributed. Such input datasets may be used to determine an effect (e.g., an influence) of each data point of the input dataset on graph neural networks (GNNs).

GNNs are designed to receive graph data (e.g., graph data representing graphs), including node data and edge data. However, graph data received by GNNs may not be independent and/or identically distributed. As such, it may be more difficult to determine an effect of a data point of the graph data on one or more GNNs. In some cases, the one or more GNNs may be relatively large and/or may require a relatively large amount of computing resources (e.g., processor resources, memory resources, and/or the like) to train and use. Additionally, the one or more GNNs may receive a relatively large amount of data for training (e.g., input datasets including graph data) and/or may require a large amount of memory during training. Determining an effect (e.g., a measure of influence) of each data point of the graph data in an input dataset may require retraining the one or more GNNs for each data point of the graph data where an effect of the data point is to be determined. Additionally, training the one or more GNNs and generating an output (e.g., a prediction) with the one or more GNNs may not accurately determine an effect of a data point of the graph data on the one or more GNNs.

### SUMMARY

Accordingly, provided are improved systems, methods, and computer program products for determining influence of a node of a graph on a graph neural network (GNN).

According to some non-limiting embodiments or aspects, provided is a computer-implemented method for determining influence of a node of a graph on a GNN. In some non-limiting embodiments or aspects, the method may include receiving, with at least one processor, a dataset including graph data associated with a graph, the graph data including node data associated with a plurality of nodes of the graph and edge data associated with a plurality of edges of the graph. In some non-limiting embodiments or aspects, the method may include selecting, with at least one processor, a target node of the plurality of nodes based on the graph data. In some non-limiting embodiments or aspects, the method may include determining, with at least one processor, target node data associated with the target node and target edge data associated with the target node based on the graph data, the node data of the graph data including the target node data and the edge data of the graph data including the target edge data, wherein the target node may be associated with one or more target edges of the plurality of edges, the one or more target edges including one or more edges connected to the target node in the graph. In some non-limiting embodiments or aspects, the method may include removing, with at least one processor, the target node data and the target edge data from the dataset to provide a target graph dataset, wherein the target graph dataset includes the dataset with the target node data and the target edge data removed. In some non-limiting embodiments or aspects, the method may include determining, with at least one processor, a measure of influence of the target node on a GNN based on the target graph dataset, wherein the GNN was trained using the dataset. In some non-limiting embodiments or aspects, the method may include detecting, with the at least one processor, an anomaly in the GNN based on the measure of influence of the target node on the GNN.

In some non-limiting embodiments or aspects, the method may further include training an initial GNN based on the dataset to provide the GNN.

In some non-limiting embodiments or aspects, determining the measure of influence of the target node on the GNN based on the target graph dataset may include: determining a set of first model parameters for the GNN based on the dataset; determining a set of modified model parameters for the GNN based on the target graph dataset; and determining a difference between a first prediction of the GNN based on the set of first model parameters and a second prediction of the GNN based on the set of modified model parameters.

In some non-limiting embodiments or aspects, determining the measure of influence of the target node on the GNN based on the target graph dataset may include: determining a first measure of influence of the target node on the GNN, wherein the first measure of influence may be associated with properties of the target node with regard to topology of the graph; determining a second measure of influence of the target node on the GNN, wherein the second measure of influence may be associated with features of the target node; determining a third measure of influence of the target node on the GNN, wherein the third measure of influence may be associated with the target graph dataset; combining the first measure of influence, the second measure of influence, and the third measure of influence to provide an influence matrix; and determining the measure of influence of the target node on the GNN based on a loss function and the influence matrix.

In some non-limiting embodiments or aspects, determining the first measure of influence of the target node on the GNN may include determining the first measure of influence of the target node on the GNN based on a Hessian matrix.

In some non-limiting embodiments or aspects, determining the second measure of influence of the target node on the GNN may include determining the second measure of influence of the target node on the GNN based on a Hessian matrix.

In some non-limiting embodiments or aspects, determining the third measure of influence of the target node on the GNN may include determining the third measure of influence of the target node on the GNN based on a Hessian matrix.

In some non-limiting embodiments or aspects, detecting the anomaly in the GNN based on the measure of influence of the target node on the GNN may include determining a measure of fairness for the GNN based on the measure of influence of the target node on the GNN; and detecting that the measure of fairness for the GNN satisfies a predetermined threshold.

In some non-limiting embodiments or aspects, removing the target node data and the target edge data from the dataset may include removing the target node and the one or more target edges from the graph.

According to non-limiting embodiments or aspects, provided is a system comprising: at least one processor programmed or configured to receive a dataset comprising graph data associated with a graph, the graph data including node data associated with a plurality of nodes of the graph and edge data associated with a plurality of edges of the graph. In some non-limiting embodiments or aspects, the at least one processor may be programmed or configured to select a target node of the plurality of nodes based on the graph data. In some non-limiting embodiments or aspects, the at least one processor may be programmed or configured to determine target node data associated with the target node and target edge data associated with the target node based on the graph data, the node data of the graph data including the target node data and the edge data of the graph data including the target edge data, the target node may be associated with one or more target edges of the plurality of edges, the one or more target edges comprising one or more edges connected to the target node in the graph. In some non-limiting embodiments or aspects, the at least one processor may be programmed or configured to remove the target node data and the target edge data from the dataset to provide a target graph dataset, the target graph dataset including the dataset with the target node data and the target edge data removed. In some non-limiting embodiments or aspects, the at least one processor may be programmed or configured to determine a measure of influence of the target node on a GNN based on the target graph dataset, the GNN was trained using the dataset. In some non-limiting embodiments or aspects, the at least one processor may be programmed or configured to detect an anomaly in the GNN based on the measure of influence of the target node on the GNN.

In non-limiting embodiments or aspects, the at least one processor may be programmed or configured to train an initial GNN based on the dataset to provide the GNN.

In non-limiting embodiments or aspects, wherein, when determining the measure of influence of the target node on the GNN based on the target graph dataset, the at least one processor may be programmed or configured to: determine a set of first model parameters for the GNN based on the dataset; determine a set of modified model parameters for the GNN based on the target graph dataset; and determine a difference between a first prediction of the GNN based on the set of first model parameters and a second prediction of the GNN based on the set of modified model parameters.

In non-limiting embodiments or aspects, wherein, when determining the measure of influence of the target node on the GNN based on the target graph dataset, the at least one processor may be programmed or configured to: determine a first measure of influence of the target node on the GNN, the first measure of influence may be associated with properties of the target node with regard to topology of the graph; determine a second measure of influence of the target node on the GNN, the second measure of influence may be associated with features of the target node; determine a third measure of influence of the target node on the GNN, the third measure of influence may be associated with the target graph dataset; combine the first measure of influence, the second measure of influence, and the third measure of influence to provide an influence matrix; and determine the measure of influence of the target node on the GNN based on a loss function and the influence matrix.

In non-limiting embodiments or aspects, wherein, when determining the first measure of influence of the target node on the GNN, the at least one processor may be programmed or configured to: determine the first measure of influence of the target node on the GNN based on a Hessian matrix.

In non-limiting embodiments or aspects, wherein, when determining the second measure of influence of the target node on the GNN, the at least one processor may be programmed or configured to: determine the second measure of influence of the target node on the GNN based on a Hessian matrix.

In non-limiting embodiments or aspects, wherein, when determining the third measure of influence of the target node on the GNN, the at least one processor may be programmed or configured to determine the third measure of influence of the target node on the GNN based on a Hessian matrix.

In non-limiting embodiments or aspects, wherein, when detecting the anomaly in the GNN based on the measure of influence of the target node on the GNN, the at least one processor may be programmed or configured to: determine a measure of fairness for the GNN based on the measure of influence of the target node on the GNN; and detect that the measure of fairness for the GNN satisfies a predetermined threshold.

In non-limiting embodiments or aspects, wherein, when removing the target node data and the target edge data from the dataset, the at least one processor may be programmed or configured to: remove the target node and the one or more target edges from the graph.

According to non-limiting embodiments or aspects, provided is a computer program product comprising at least one non-transitory computer-readable medium including one or more instructions that, when executed by at least one processor, cause the at least one processor to receive a dataset comprising graph data associated with a graph, the graph data including node data associated with a plurality of nodes of the graph and edge data associated with a plurality of edges of the graph. In some non-limiting embodiments or aspects, the one or more instructions may further cause the at least one processor to select a target node of the plurality of nodes based on the graph data. In some non-limiting embodiments or aspects, the one or more instructions may further cause the at least one processor to determine target node data associated with the target node and target edge data associated with the target node based on the graph data, the node data of the graph data including the target node data and the edge data of the graph data including the target edge data, the target node may be associated with one or more target edges of the plurality of edges, the one or more target edges comprising one or more edges connected to the target node in the graph. In some non-limiting embodiments or aspects, the one or more instructions may further cause the at least one processor to remove the target node data and the target edge data from the dataset to provide a target graph dataset, the target graph dataset including the dataset with the target node data and the target edge data removed. In some non-limiting embodiments or aspects, the one or more instructions may further cause the at least one processor to determine a measure of influence of the target node on a GNN based on the target graph dataset, the GNN was trained using the dataset. In some non-limiting embodiments or aspects, the one or more instructions may further cause the at least one processor to detect an anomaly in the GNN based on the measure of influence of the target node on the GNN.

In non-limiting embodiments or aspects, the one or more instructions may further cause the at least one processor to: train an initial graph neural network based on the dataset to provide the GNN.

In non-limiting embodiments or aspects, wherein, when determining the measure of influence of the target node on the GNN based on the target graph dataset, the one or more instructions may cause the at least one processor to: determine a set of first model parameters for the GNN based on the dataset; determine a set of modified model parameters for the GNN based on the target graph dataset; and determine a difference between a first prediction of the GNN based on the set of first model parameters and a second prediction of the GNN based on the set of modified model parameters.

In non-limiting embodiments or aspects, wherein, when determining the measure of influence of the target node on the GNN based on the target graph dataset, the one or more instructions may cause the at least one processor to: determine a first measure of influence of the target node on the GNN, the first measure of influence may be associated with properties of the target node with regard to topology of the graph; determine a second measure of influence of the target node on the GNN, the second measure of influence may be associated with features of the target node; determine a third measure of influence of the target node on the GNN, the third measure of influence may be associated with the target graph dataset; combine the first measure of influence, the second measure of influence, and the third measure of influence to provide an influence matrix; and determine the measure of influence of the target node on the GNN based on a loss function and the influence matrix.

In non-limiting embodiments or aspects, wherein, when determining the first measure of influence of the target node on the GNN, the one or more instructions may cause the at least one processor to: determine the first measure of influence of the target node on the GNN based on a Hessian matrix.

In non-limiting embodiments or aspects, wherein, when determining the second measure of influence of the target node on the GNN, the one or more instructions may cause the at least one processor to: determine the second measure of influence of the target node on the GNN based on a Hessian matrix.

In non-limiting embodiments or aspects, wherein, when determining the third measure of influence of the target node on the GNN, the one or more instructions may cause the at least one processor to determine the third measure of influence of the target node on the GNN based on a Hessian matrix.

In non-limiting embodiments or aspects, wherein, when detecting the anomaly in the GNN based on the measure of influence of the target node on the GNN, the one or more instructions may cause the at least one processor to: determine a measure of fairness for the GNN based on the measure of influence of the target node on the GNN; and detect that the measure of fairness for the GNN satisfies a predetermined threshold.

In non-limiting embodiments or aspects, wherein, when removing the target node data and the target edge data from the dataset, the one or more instructions may cause the at least one processor to: remove the target node and the one or more target edges from the graph.

Further non-limiting embodiments or aspects are set forth in the following numbered clauses:

Clause 1: A computer-implemented method, comprising: receiving, with at least one processor, a dataset comprising graph data associated with a graph, the graph data comprising node data associated with a plurality of nodes of the graph and edge data associated with a plurality of edges of the graph; selecting, with at least one processor, a target node of the plurality of nodes based on the graph data; determining, with at least one processor, target node data associated with the target node and target edge data associated with the target node based on the graph data, the node data of the graph data comprising the target node data and the edge data of the graph data comprising the target edge data, wherein the target node is associated with one or more target edges of the plurality of edges, the one or more target edges comprising one or more edges connected to the target node in the graph; removing, with at least one processor, the target node data and the target edge data from the dataset to provide a target graph dataset, wherein the target graph dataset comprises the dataset with the target node data and the target edge data removed; determining, with at least one processor, a measure of influence of the target node on a graph neural network (GNN) based on the target graph dataset, wherein the GNN was trained using the dataset; and detecting, with the at least one processor, an anomaly in the GNN based on the measure of influence of the target node on the GNN.

Clause 2: The computer-implemented method of clause 1, further comprising: training an initial GNN based on the dataset to provide the GNN.

Clause 3: The computer-implemented method of clause 1 or 2, wherein determining the measure of influence of the target node on the GNN based on the target graph dataset comprises: determining a set of first model parameters for the GNN based on the dataset; determining a set of modified model parameters for the GNN based on the target graph dataset; and determining a difference between a first prediction of the GNN based on the set of first model parameters and a second prediction of the GNN based on the set of modified model parameters.

Clause 4: The computer-implemented method of any of clauses 1-3, wherein determining the measure of influence of the target node on the GNN based on the target graph dataset comprises: determining a first measure of influence of the target node on the GNN, wherein the first measure of influence is associated with properties of the target node with regard to topology of the graph; determining a second measure of influence of the target node on the GNN, wherein the second measure of influence is associated with features of the target node; determining a third measure of influence of the target node on the GNN, wherein the third measure of influence is associated with the target graph dataset; combining the first measure of influence, the second measure of influence, and the third measure of influence to provide an influence matrix; and determining the measure of influence of the target node on the GNN based on a loss function and the influence matrix.

Clause 5: The computer-implemented method of any of clauses 1-4, wherein determining the first measure of influence of the target node on the GNN comprises determining the first measure of influence of the target node on the GNN based on a Hessian matrix.

Clause 6: The computer-implemented method of any of clauses 1-5, wherein determining the second measure of influence of the target node on the GNN comprises determining the second measure of influence of the target node on the GNN based on a Hessian matrix.

Clause 7: The computer-implemented method of any of clauses 1-6, wherein determining the third measure of influence of the target node on the GNN comprises determining the third measure of influence of the target node on the GNN based on a Hessian matrix.

Clause 8: The computer-implemented method of any of clauses 1-7, wherein detecting the anomaly in the GNN based on the measure of influence of the target node on the GNN comprises: determining a measure of fairness for the GNN based on the measure of influence of the target node on the GNN; and detecting that the measure of fairness for the GNN satisfies a predetermined threshold.

Clause 9: The computer-implemented method of any of clauses 1-8, wherein removing the target node data and the target edge data from the dataset comprises removing the target node and the one or more target edges from the graph.

Clause 10: A system comprising: at least one processor programmed or configured to: receive a dataset comprising graph data associated with a graph, the graph data comprising node data associated with a plurality of nodes of the graph and edge data associated with a plurality of edges of the graph; select a target node of the plurality of nodes based on the graph data; determine target node data associated with the target node and target edge data associated with the target node based on the graph data, the node data of the graph data comprising the target node data and the edge data of the graph data comprising the target edge data, wherein the target node is associated with one or more target edges of the plurality of edges, the one or more target edges comprising one or more edges connected to the target node in the graph; remove the target node data and the target edge data from the dataset to provide a target graph dataset, wherein the target graph dataset comprises the dataset with the target node data and the target edge data removed; determine a measure of influence of the target node on a graph neural network (GNN) based on the target graph dataset, wherein the GNN was trained using the dataset; and detect an anomaly in the GNN based on the measure of influence of the target node on the GNN.

Clause 11: The system of clause 10, wherein the at least one processor is further programmed or configured to: train an initial GNN based on the dataset to provide the GNN.

Clause 12: The system of clause 10 or 11, wherein, when determining the measure of influence of the target node on the GNN based on the target graph dataset, the at least one processor is programmed or configured to: determine a set of first model parameters for the GNN based on the dataset; determine a set of modified model parameters for the GNN based on the target graph dataset; and determine a difference between a first prediction of the GNN based on the set of first model parameters and a second prediction of the GNN based on the set of modified model parameters.

Clause 13: The system of any of clauses 10-12, wherein, when determining the measure of influence of the target node on the GNN based on the target graph dataset, the at least one processor is programmed or configured to: determine a first measure of influence of the target node on the GNN, wherein the first measure of influence is associated with properties of the target node with regard to topology of the graph; determine a second measure of influence of the target node on the GNN, wherein the second measure of influence is associated with features of the target node; determine a third measure of influence of the target node on the GNN, wherein the third measure of influence is associated with the target graph dataset; combine the first measure of influence, the second measure of influence, and the third measure of influence to provide an influence matrix; and determine the measure of influence of the target node on the GNN based on a loss function and the influence matrix.

Clause 14: The system of any of clauses 10-13, wherein, when determining the first measure of influence of the target node on the GNN, the at least one processor is programmed or configured to: determine the first measure of influence of the target node on the GNN based on a Hessian matrix.

Clause 15: The system of any of clauses 10-14, wherein, when determining the second measure of influence of the target node on the GNN, the at least one processor is programmed or configured to: determine the second measure of influence of the target node on the GNN based on a Hessian matrix.

Clause 16: The system of any of clauses 10-15, wherein, when determining the third measure of influence of the target node on the GNN, the at least one processor is programmed or configured to: determine the third measure of influence of the target node on the GNN based on a Hessian matrix.

Clause 17: The system of any of clauses 10-16, wherein, when detecting the anomaly in the GNN based on the measure of influence of the target node on the GNN, the at least one processor is programmed or configured to: determine a measure of fairness for the GNN based on the measure of influence of the target node on the GNN; and detect that the measure of fairness for the GNN satisfies a predetermined threshold.

Clause 18: The system of any of clauses 10-17, wherein, when removing the target node data and the target edge data from the dataset, the at least one processor is programmed or configured to: remove the target node and the one or more target edges from the graph.

Clause 19: A computer program product comprising at least one non-transitory computer-readable medium including one or more instructions that, when executed by at least one processor, cause the at least one processor to: receive a dataset comprising graph data associated with a graph, the graph data comprising node data associated with a plurality of nodes of the graph and edge data associated with a plurality of edges of the graph; select a target node of the plurality of nodes based on the graph data; determine target node data associated with the target node and target edge data associated with the target node based on the graph data, the node data of the graph data comprising the target node data and the edge data of the graph data comprising the target edge data, wherein the target node is associated with one or more target edges of the plurality of edges, the one or more target edges comprising one or more edges connected to the target node in the graph; remove the target node data and the target edge data from the dataset to provide a target graph dataset, wherein the target graph dataset comprises the dataset with the target node data and the target edge data removed; determine a measure of influence of the target node on a graph neural network (GNN) based on the target graph dataset, wherein the GNN was trained using the dataset; and detect an anomaly in the GNN based on the measure of influence of the target node on the GNN.

Clause 20: The computer program product of clause 19, wherein the one or more instructions further cause the at least one processor to: train an initial GNN based on the dataset to provide the GNN.

Clause 21: The computer program product of clause 19 or 20, wherein, when determining the measure of influence of the target node on the GNN based on the target graph dataset, the one or more instructions cause the at least one processor to: determine a set of first model parameters for the GNN based on the dataset; determine a set of modified model parameters for the GNN based on the target graph dataset; and determine a difference between a first prediction of the GNN based on the set of first model parameters and a second prediction of the GNN based on the set of modified model parameters.

Clause 22: The computer program product of any of clauses 19-21, wherein, when determining the measure of influence of the target node on the GNN based on the target graph dataset, the one or more instructions cause the at least one processor to: determine a first measure of influence of the target node on the GNN, wherein the first measure of influence is associated with properties of the target node with regard to topology of the graph; determine a second measure of influence of the target node on the GNN, wherein the second measure of influence is associated with features of the target node; determine a third measure of influence of the target node on the GNN, wherein the third measure of influence is associated with the target graph dataset; combine the first measure of influence, the second measure of influence, and the third measure of influence to provide an influence matrix; and determine the measure of influence of the target node on the GNN based on a loss function and the influence matrix.

Clause 23: The computer program product of any of clauses 19-22, wherein, when determining the first measure of influence of the target node on the GNN, the one or more instructions cause the at least one processor to: determine the first measure of influence of the target node on the GNN based on a Hessian matrix.

Clause 24: The computer program product of any of clauses 19-23, wherein, when determining the second measure of influence of the target node on the GNN, the one or more instructions cause the at least one processor to: determine the second measure of influence of the target node on the GNN based on a Hessian matrix.

Clause 25: The computer program product of any of clauses 19-24, wherein, when determining the third measure of influence of the target node on the GNN, the one or more instructions cause the at least one processor to: determine the third measure of influence of the target node on the GNN based on a Hessian matrix.

Clause 26: The computer program product of any of clauses 19-25, wherein, when detecting the anomaly in the GNN based on the measure of influence of the target node on the GNN, the one or more instructions cause the at least one processor to: determine a measure of fairness for the GNN based on the measure of influence of the target node on the GNN; and detect that the measure of fairness for the GNN satisfies a predetermined threshold.

Clause 27: The computer program product of any of clauses 19-26, wherein, when removing the target node data and the target edge data from the dataset, the one or more instructions cause the at least one processor to: remove the target node and the one or more target edges from the graph.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an example environment in which devices, systems, and/or methods, described herein, may be implemented according to the principles of the present disclosure;

FIG. 2 is a schematic diagram of example components of one or more devices of FIG. 1 according to some non-limiting embodiments or aspects;

FIG. 3 is a flow diagram of a process for determining influence of a node of a graph on a graph neural network (GNN) according to some non-limiting embodiments or aspects; and

FIGS. 4A-4M are diagrams of non-limiting embodiments or aspects of an implementation of a process for determining influence of a node of a graph on a GNN according to some non-limiting embodiments or aspects.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more point-of-sale (POS) devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices and/or components of such (e.g., processors, servers, client devices, software applications, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for determining influence of data on a graph neural network (GNN), including, but not limited to, determining influence of a node of a graph on a GNN. Non-limiting embodiments or aspects of the disclosed subject matter may receive a dataset including graph data associated with a graph. The graph data may include node data associated with a plurality of nodes of the graph and edge data associated with a plurality of edges of the graph. Non-limiting embodiments or aspects may select a target node of the plurality of nodes based on the graph data. Non-limiting embodiments or aspects may determine target node data associated with the target node and target edge data associated with the target node based on the graph data. The node data of the graph data may include the target node data and the edge data of the graph data may include the target edge data. The target node may be associated with one or more target edges of the plurality of edges. The one or more target edges may include one or more edges connected to the target node in the graph. Non-limiting embodiments or aspects may remove the target node data and the target edge data from the dataset to provide a target graph dataset. The target graph dataset may include the dataset with the target node data and the target edge data removed. Non-limiting embodiments or aspects may determine a measure of influence of the target node on a GNN (e.g., a trained GNN) based on the target graph dataset. The GNN may be trained using the dataset. Non-limiting embodiments or aspects may detect an anomaly in the GNN based on the measure of influence of the target node on the GNN.

Non-limiting embodiments or aspects may train an initial GNN based on the dataset to provide the GNN.

In some non-limiting embodiments or aspects, determining the measure of influence of the target node on the GNN based on the target graph dataset may include: determining a set of first model parameters for the GNN based on the dataset; determining a set of modified model parameters for the GNN based on the target graph dataset; and determining a difference between a first prediction of the GNN based on the set of first model parameters and a second prediction of the GNN based on the set of modified model parameters.

In some non-limiting embodiments or aspects, determining the measure of influence of the target node on the GNN based on the target graph dataset may include: determining a first measure of influence of the target node on the GNN, wherein the first measure of influence may be associated with properties of the target node with regard to topology of the graph; determining a second measure of influence of the target node on the GNN, wherein the second measure of influence may be associated with features of the target node; determining a third measure of influence of the target node on the GNN, wherein the third measure of influence may be associated with the target graph dataset; combining the first measure of influence, the second measure of influence, and the third measure of influence to provide an influence matrix; and determining the measure of influence of the target node on the GNN based on a loss function and the influence matrix.

In some non-limiting embodiments or aspects, determining the first measure of influence of the target node on the GNN may include determining the first measure of influence of the target node on the GNN based on a Hessian matrix.

In some non-limiting embodiments or aspects, determining the second measure of influence of the target node on the GNN may include determining the second measure of influence of the target node on the GNN based on a Hessian matrix.

In some non-limiting embodiments or aspects, determining the third measure of influence of the target node on the GNN may include determining the third measure of influence of the target node on the GNN based on a Hessian matrix.

In some non-limiting embodiments or aspects, detecting the anomaly in the GNN based on the measure of influence of the target node on the GNN may include determining a measure of fairness for the GNN based on the measure of influence of the target node on the GNN; and detecting that the measure of fairness for the GNN satisfies a predetermined threshold.

In some non-limiting embodiments or aspects, removing the target node data and the target edge data from the dataset may include removing the target node and the one or more target edges from the graph.

In this way, non-limiting embodiments or aspects of the disclosed subject matter may determine influence of a node of a graph on a GNN (e.g., a trained GNN) without having to retrain the GNN using the dataset and/or the target graph dataset. For example, non-limiting embodiments or aspects of the disclosed subject matter may determine an influence (e.g., a measure of influence) that an instance of training data (e.g., a node, and edge, and/or the like) may have on an output (e.g., a prediction) of the GNN. A different influence (e.g., a different measure of influence) may be determined for different instances of data based on an input (e.g., a test input, a production input) to the GNN that produces an output. For example, each instance of training data of a plurality of instances of training data may each have a different influence on the GNN, such that when an input is provided to the GNN, the GNN may produce (e.g., generate) a different output. The difference in the output of the GNN may be related to the influence of an instance of training data.

Non-limiting embodiments or aspects do not require the GNN to be retrained with the target graph dataset in order to determine influence of a node on the GNN. In this way, non-limiting embodiments or aspects may reduce the amount of resources required to determine a measure of influence of a node of a graph on a GNN.

Non-limiting embodiments or aspects of the disclosed subject matter may determine influence of a node of a graph on a GNN to provide insight (e.g., data) into graphs and/or GNNs. For example, non-limiting embodiments or aspects may be used to analyze the strength of a GNN against manipulation of a graph and/or the GNN (e.g., graph attacks). In this way, non-limiting embodiments or aspects may improve a robustness of a GNN against attacks. As a further example, non-limiting embodiments or aspects may be used to analyze the output of a GNN for different measures of influence based on node data of the dataset (e.g., target node data). Non-limiting embodiments or aspects may improve training and/or accuracy of the GNN by analyzing the output (e.g., predictions) of the GNN and determining which nodes (e.g., target nodes) have the greatest influence on the output of the GNN.

In this way, non-limiting embodiments or aspects may improve fairness and/or quality of predictions by the GNN (e.g., node classification). Thus, non-limiting embodiments or aspects of the disclosed subject matter may improve the training and/or use of GNNs without requiring the GNN to be retrained on multiple datasets. In this way, non-limiting embodiments or aspects of the disclosed subject matter may reduce the overall time and/or resources required to train a GNN.

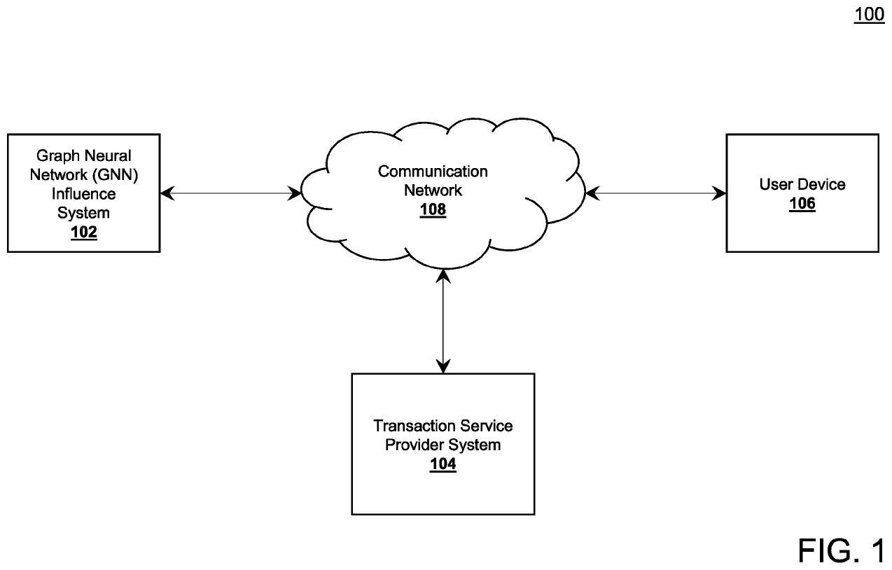

Referring now to FIG. 1, FIG. 1 is a diagram of an example environment 100 in which devices, systems, and/or methods, described herein, may be implemented. As shown in FIG. 1, environment 100 includes GNN influence system 102, transaction service provider system 104, user device 106, and communication network 108. GNN influence system 102, transaction service provider system 104, and/or user device 106 may interconnect (e.g., establish a connection to communicate) via wired connections, wireless connections, or a combination of wired and wireless connections.

GNN influence system 102 may include a computing device, such as a server (e.g., a single server), a group of servers, and/or other like devices. In some non-limiting embodiments or aspects, GNN influence system 102 may include a processor and/or memory, as described herein. In some non-limiting embodiments or aspects, GNN influence system 102 may include one or more software instructions (e.g., one or more software applications) executing on a server (e.g., a single server), a group of servers, a computing device (e.g., a single computing device), a group of computing devices, and/or other like devices. In some non-limiting embodiments or aspects, GNN influence system 102 may be configured to communicate with transaction service provider system 104 and/or user device 106 via communication network 108. In some non-limiting embodiments or aspects, GNN influence system 102 may be in communication with transaction service provider system 104 and/or user device 106, such that GNN influence system 102 is separate from transaction service provider system 104 and/or user device 106. In some non-limiting embodiments or aspects, transaction service provider system 104 and/or user device 106 may be implemented by (e.g., may be part of) GNN influence system 102.

In some non-limiting embodiments or aspects, GNN influence system 102 may be associated with a transaction service provider system, as described herein. Additionally or alternatively, GNN influence system 102 may generate (e.g., train, validate, retrain, and/or the like), store, and/or implement (e.g., operate, provide inputs to and/or outputs from, and/or the like) one or more machine learning models. In some non-limiting embodiments or aspects, GNN influence system 102 may be in communication with a data storage device, which may be local or remote to GNN influence system 102. In some non-limiting embodiments or aspects, GNN influence system 102 may be capable of receiving information from, storing information in, transmitting information to, and/or searching information stored in the data storage device.

Transaction service provider system 104 may include one or more devices configured to communicate with GNN influence system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider system as discussed herein. In some non-limiting embodiments or aspects, GNN influence system 102 may be a component of transaction service provider system 104.

User device 106 may include a computing device configured to communicate with GNN influence system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106).

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

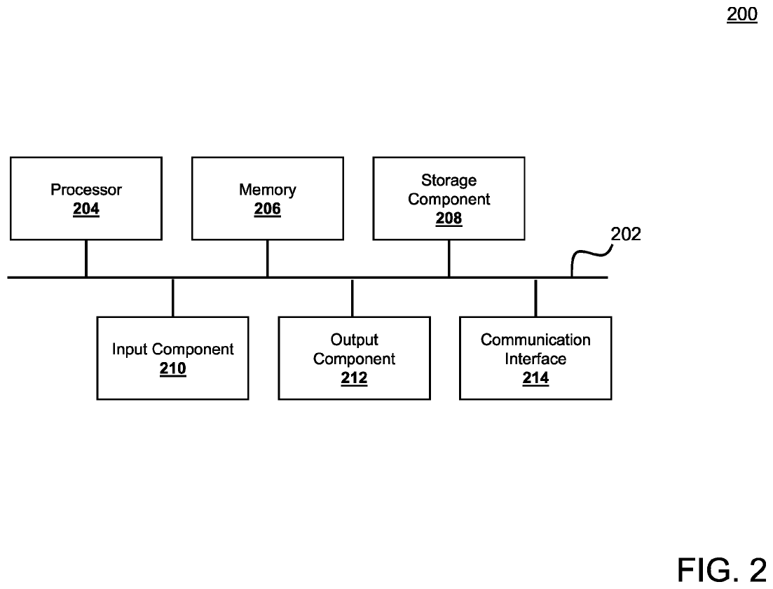

Referring now to FIG. 2, FIG. 2 is a diagram of example components of a device 200. Device 200 may correspond to GNN influence system 102 (e.g., one or more devices of GNN influence system 102), transaction service provider system 104 (e.g., one or more devices of transaction service provider system 104), and/or user device 106. In some non-limiting embodiments or aspects, GNN influence system 102, transaction service provider system 104, and/or user device 106 may include at least one device 200 or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “programmed to” and/or “configured to,” as used herein, may refer to an arrangement of software, device(s), and/or hardware for performing and/or enabling one or more functions (e.g., actions, processes, steps of a process, and/or the like). For example, “a processor programmed or configured to” may refer to a processor that executes software instructions (e.g., program code) that cause the processor to perform one or more functions.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

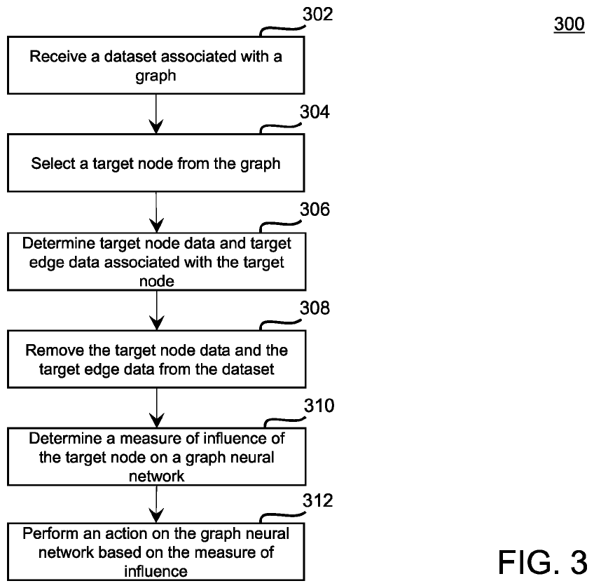

Referring now to FIG. 3, FIG. 3 is a flowchart of a non-limiting embodiment or aspect of a process 300 for determining influence of a node of a graph on a GNN. In some non-limiting embodiments or aspects, one or more of the steps of process 300 may be performed (e.g., completely, partially, etc.) by GNN influence system 102 (e.g., one or more devices of GNN influence system 102). In some non-limiting embodiments or aspects, one or more of the steps of process 300 may be performed (e.g., completely, partially, etc.) by another device or a group of devices separate from or including GNN influence system 102 (e.g., one or more devices of GNN influence system 102), transaction service provider system 104 (e.g., one or more devices of transaction service provider system 104), and/or user device 106.

As shown in FIG. 3, at step 302, process 300 may include receiving a dataset associated with a graph. For example, GNN influence system 102 may receive a dataset including graph data associated with a graph. In some non-limiting embodiments or aspects, the graph may include a plurality of nodes and/or a plurality of edges. In some non-limiting embodiments or aspects, each edge of the plurality of edges of the graph may connect a node of the plurality of nodes of the graph with another node of the plurality of nodes of the graph. In some non-limiting embodiments or aspects, the graph data may include node data associated with the plurality of nodes of the graph and/or edge data associated with the plurality of edges of the graph.

In some non-limiting embodiments or aspects, GNN influence system 102 may receive a dataset for a population that includes a plurality of data instances associated with a plurality of features. For example, GNN influence system 102 may receive a dataset for a population (e.g., a population of individuals, such as account holders, users associated with an account, etc.) that includes a plurality of data instances associated with a plurality of features. In some non-limiting embodiments or aspects, the plurality of data instances may represent a plurality of transactions (e.g., electronic payment transactions) conducted by the population. In some non-limiting embodiments or aspects, GNN influence system 102 may receive the dataset from transaction service provider system 104 and/or user device 106.

In some non-limiting embodiments or aspects, each data instance may include transaction data associated with the transaction. In some non-limiting embodiments or aspects, the transaction data may include a plurality of transaction parameters associated with an electronic payment transaction. In some non-limiting embodiments or aspects, the plurality of features may represent the plurality of transaction parameters. In some non-limiting embodiments or aspects, the plurality of transaction parameters may include electronic wallet card data associated with an electronic card (e.g., an electronic credit card, an electronic debit card, an electronic loyalty card, and/or the like), decision data associated with a decision (e.g., a decision to approve or deny a transaction authorization request), authorization data associated with an authorization response (e.g., an approved spending limit, an approved transaction value, and/or the like), a PAN, an authorization code (e.g., a personal identification number (PIN), etc.), data associated with a transaction amount (e.g., an approved limit, a transaction value, etc.), data associated with a transaction date and time, data associated with a conversion rate of a currency, data associated with a merchant type (e.g., a merchant category code that indicates a type of goods, such as grocery, fuel, and/or the like), data associated with an acquiring institution country, data associated with an identifier of a country associated with the PAN, data associated with a response code, data associated with a merchant identifier (e.g., a merchant name, a merchant location, and/or the like), data associated with a type of currency corresponding to funds stored in association with the PAN, and/or the like.

In some non-limiting embodiments or aspects, each node of the plurality of nodes may be associated with an entity of a plurality of entities, such as an account holder or a merchant. In some non-limiting embodiments or aspects, each edge of the plurality of edges may be associated with a relationship, such as a transaction between two entities of the plurality of entities. For example, a first node may be connected to a second node by an edge. The first node may be associated with a first entity, and the second node may be associated with a second entity. The edge connecting the first node and the second node may represent a relationship (e.g., a transaction) between the first entity and the second entity.

In some non-limiting embodiments or aspects, GNN influence system 102 may include a machine learning model. The machine learning model may include a GNN machine learning model configured to provide an output that includes a prediction. For example, GNN influence system 102 may train a GNN to provide an output that includes a prediction regarding whether a node of a graph is an anomaly, whether a node of a graph indicates corruption or label noise within the dataset, and/or whether a training strategy for the GNN is a fair training strategy. For example, GNN influence system 102 may train an initial GNN based on the dataset to provide a GNN (e.g., a trained GNN). In some non-limiting embodiments or aspects, training the initial GNN may include generating the initial GNN, training the initial GNN based on the dataset, and/or re-training the initial GNN based on the dataset. In some non-limiting embodiments or aspects, the GNN may include one or more layers. For example, the GNN may include an input layer, one or more hidden layers, and/or an output layer.

In some non-limiting embodiments or aspects, the GNN may output a prediction (e.g., a confidence score) based on receiving the dataset as an input. In some non-limiting embodiments or aspects, the GNN may be trained to perform one or more tasks. For example, the GNN may classify a node of the plurality of nodes.

As shown in FIG. 3, at step 304, process 300 may include selecting a target node from the graph. For example, GNN influence system 102 may select a target node of the plurality of nodes from the graph. In some non-limiting embodiments or aspects, GNN influence system 102 may select the target node based on graph data (e.g., node data associated with a plurality of nodes of a graph and/or edge data associated with a plurality of edges of the graph).

In some non-limiting embodiments or aspects, GNN influence system 102 may select the target node randomly. For example, GNN influence system 102 may select a node of the plurality of nodes at random (e.g., based on a random number generator) to be the target node.

In some non-limiting embodiments or aspects, GNN influence system 102 may select the target node based on a criteria (e.g., data associated with graph topology of the graph, such as data associated with the plurality of nodes and/or data associated with the plurality of edges, adjacency data, such as data associated with adjacent nodes and/or data associated with adjacent edges for a given node, etc.). In some non-limiting embodiments or aspects, GNN influence system 102 may select the target node from all of the plurality of nodes. In some non-limiting embodiments or aspects, GNN influence system 102 may select the target nodes from all of the plurality of nodes in an order.

As shown in FIG. 3, at step 306, process 300 may include determining target node data and target edge data associated with the target node. For example, GNN influence system 102 may determine target node data associated with the target node and target edge data associated with the target node based on the graph data. In some non-limiting embodiments or aspects, the node data of the graph data may include the target node data, and the edge data of the graph data may include the target edge data.

In some non-limiting embodiments or aspects, the target node may be associated with one or more target edges of the plurality of edges. In some non-limiting embodiments or aspects, the one or more target edges may include one or more edges connected to the target node in the graph. In some non-limiting embodiments or aspects, the target node may be connected to another node of the plurality of nodes via a target edge. In some non-limiting embodiments or aspects, an edge of the plurality of edges connected to the target node may be a target edge.

In some non-limiting embodiments or aspects, a node of the plurality of nodes connected to the target node by an edge may be an adjacent node. In some non-limiting embodiments or aspects, a target edge may be an edge which is adjacent to the target node (e.g., an adjacent edge to the target node).

As shown in FIG. 3, at step 308, process 300 may include removing the target node data and the target edge data from the dataset. For example, GNN influence system 102 may remove (e.g., delete) the target node data and the target edge data from the dataset to provide a target graph dataset. In some non-limiting embodiments or aspects, the target graph dataset may include the dataset with the target node data and the target edge data removed (e.g., the target graph dataset does not include the target node data and/or the target edge data). In some non-limiting embodiments or aspects, GNN influence system 102 may remove the target node data and the target edge data from the dataset by removing the target node and the one or more target edges from the graph.

In some non-limiting embodiments or aspects, GNN influence system 102 may store the target graph dataset in a database (not shown). GNN influence system 102 may include the database. In some non-limiting embodiments or aspects, the database may be external from GNN influence system 102. In some non-limiting embodiments or aspects, the database may include a plurality of target graph datasets.

As shown in FIG. 3, at step 310, process 300 may include determining a measure of influence of the target node on a GNN. For example, GNN influence system 102 may determine a measure of influence of the target node on the GNN based on the dataset and/or the target graph dataset. In some non-limiting embodiments or aspects, the GNN may be trained (e.g., the GNN was previously trained and/or the like) using the dataset.

In some non-limiting embodiments or aspects, when determining the measure of influence of the target node on the GNN based on the target graph dataset, GNN influence system 102 may determine a set of first model parameters for the GNN based on the dataset. In some non-limiting embodiments or aspects, GNN influence system 102 may provide a first prediction of the GNN based on the set of first model parameters.

In some non-limiting embodiments or aspects, when determining the measure of influence of the target node on the GNN based on the target graph dataset, GNN influence system 102 may determine a set of modified model parameters for the GNN based on the target graph dataset. In some non-limiting embodiments or aspects, GNN influence system 102 may provide a second prediction of the GNN based on the set of modified model parameters.

In some non-limiting embodiments or aspects, when determining the set of modified model parameters based on the target graph dataset, GNN influence system 102 may retrieve the target graph dataset stored in the database. For example, GNN influence system 102 may retrieve the target graph dataset from the database and input the target graph dataset into the GNN.

In some non-limiting embodiments or aspects, GNN influence system 102 may determine the measure of influence of the target node on the GNN based on the set of first model parameters, the set of modified model parameters, and/or a combination thereof. For example, when determining the measure of influence of the target node on the GNN based on the target graph dataset, GNN influence system 102 may determine a difference between the first prediction of the GNN based on the set of first model parameters and the second prediction of the GNN based on the set of modified model parameters.

In some non-limiting embodiments or aspects, the dataset may include training data samples {(x_1, y_1), [symbol] x [symbol] _2, y_2) . . . (x_n, y_n)} where n represents a number of training data samples. In some non-limiting embodiments or aspects, the set of first model parameters may be determined based on the following equation, where l(x, y, θ) is a loss function of the GNN, where xᵢ is node data associated with node i, and where yᵢ is edge data associated with node i:

$$\hat{θ} = arg {min}_{θ ∈ θ} R ( θ \vert {x}_{i} , {y}_{i} ) , i ϵ [ n ] = arg {min}_{θ ∈ θ} {\sum }_{i = 1}^{n} 〚 l ( {x}_{i} , {y}_{i} , θ 〛 )$$

In some non-limiting embodiments or aspects, GNN influence system 102 may determine the set of modified model parameters based on the following equation, where j represents the target node, and where \tilde{θ}₋ⱼ represents the model parameters for the target graph dataset (e.g., the dataset with the target node data and the target edge data removed):

$${\hat{θ}}_{- j} = arg {min}_{θ ∈ θ} {\sum }_{i = 1 , i \neq j}^{n} 〚 l ( {x}_{i} , {y}_{i} , θ ) 〛 )$$

In some non-limiting embodiments or aspects, GNN influence system 102 may approximate a parameter change for a data point by computing the parameter change for target node j, where target node j is weighted by E based on the following equation:

$${\hat{θ}}_{- j , ∈} = {arg}_{θϵ Θ} min {\sum }_{i = 1}^{n} 〚 l ( {x}_{i} , {y}_{i} , θ 〛 ) + ∈ l ( {x}_{j} , {y}_{j} , θ )$$

In some non-limiting embodiments or aspects, GNN influence system 102 may determine a first measure of influence of the target node on the GNN, a second measure of influence of the target node on the GNN, and/or a third measure of influence of the target node on the GNN.

In some non-limiting embodiments or aspects, GNN influence system 102 may determine the measure of influence of the target node on the GNN based on the target graph dataset by determining a first measure of influence of the target node on the GNN. In some non-limiting embodiments or aspects, the first measure of influence may be associated with properties of the target node with regard to topology of the graph (e.g., a degree of the graph, lengths of edges in the graph, arrangement of nodes in the graph, presence of clusters of nodes in the graph, and/or the like). In some non-limiting embodiments or aspects, GNN influence system 102 may determine the first measure of influence of the target node on the GNN by determining the first measure of influence of the target node on the GNN based on a Hessian matrix.

In some non-limiting embodiments or aspects, GNN influence system 102 may determine the measure of influence of the target node on the GNN based on the target graph dataset by determining a second measure of influence of the target node on the GNN. In some non-limiting embodiments or aspects, the second measure of influence may be associated with features of the target node (e.g., features embedded in a target node, such as a type of entity the node represents (a person, an account, and/or the like), a size of the node (e.g., representing an amount of an account that is represented by the node and/or the like)). In some non-limiting embodiments or aspects, GNN influence system 102 may determine the measure of influence of the target node on the GNN based on the target graph dataset by determining the second measure of influence of the target node on the GNN based on a Hessian matrix.

In some non-limiting embodiments or aspects, GNN influence system 102 may determine the measure of influence of the target node on the GNN based on the target graph dataset by determining a third measure of influence of the target node on the GNN. In some non-limiting embodiments or aspects, the third measure of influence may be associated with the target graph dataset (e.g., associated with a target graph including the target graph dataset, where the third measure of influence is related to a topology of the target graph). In some non-limiting embodiments or aspects, GNN influence system 102 may determine the measure of influence of the target node on the GNN based on the target graph dataset by determining the third measure of influence of the target node on the GNN based on a Hessian matrix.

In some non-limiting embodiments or aspects, GNN influence system 102 may determine the measure of influence of the target node on the GNN based on the target graph dataset by combining the first measure of influence, the second measure of influence, and the third measure of influence to provide an influence matrix. In some non-limiting embodiments or aspects, GNN influence system 102 may determine the measure of influence of the target node on the GNN based on the target graph dataset by determining the measure of influence of the target node on the GNN based on a loss function and the influence matrix.

In some non-limiting embodiments or aspects, GNN influence system 102 may determine the measure of influence of the target node on the GNN based on the first measure of influence, the second measure of influence, the third measure of influence, the influence matrix, the loss functions, and/or any combination thereof.

In some non-limiting embodiments or aspects, a Hessian matrix, He, may be a square matrix of second-order partial derivatives of a scalar-valued function which describes the local of the scalar-valued function. In some non-limiting embodiments or aspects, a Hessian matrix may be determined based on the following equation:

$${H}_{θ} = \frac{1}{n} {\sum }_{i = 1}^{n} {∇}_{θ}^{2} R ( θ \vert ( {x}_{i} , {y}_{i} ) , i ϵ [ n ] )$$

In some non-limiting embodiments or aspects, the influence of upweighting (e.g., adding additional weight to) target node j on the set of first model parameters \tilde{θ} may be determined based on the following equation, where

$${H}_{θ}^{- 1}$$

is an inverse of a Hessian matrix:

$${I}_{para} ( j ) = \frac{d {\hat{θ}}_{- j , ϵ}}{d ϵ} {\vert \vert}_{ϵ = 0} = - {H}_{θ}^{- 1} l ( {x}_{j} , {y}_{j} , θ )$$

In some non-limiting embodiments or aspects, removing the target node data and target edge data associated with target node j may have the same effect as upweighting the Hessian matrix equation by

$$ϵ = \frac{- 1}{n} .$$

In some non-limiting embodiments or aspects, removing the target node data and target edge data associated with target node j may result in a parameter change that may be linearly approximated without retraining the GNN. For example, after removing the target node data and target edge data associated with target node j, GNN influence system 102 may approximate the set of modified model parameters based on the following equation:

$$\hat{θ} - {\hat{θ}}_{- j} = \frac{1}{n} {I}_{para} ( j )$$

In some non-limiting embodiments or aspects, a change in model prediction may be determined to measure how upweighting the target node j changes the prediction based on a test dataset. For example, for a test data sample, zₜₑₛₜ=(xₜₑₛₜ,yₜₑₛₜ), with a loss function, l(zₜₑₛₜ)², the influence of upweighting the target node j on the loss at a test data sample zₜₑₛₜ may be determined based on the following equation:

$${{I}_{test} ( j , {z}_{test} ) = \frac{d \hat{l} ( {z}_{test} )}{dϵ} {‖}_{ϵ = 0} = {∇}_{θ} {\hat{l} ( {z}_{test} )}^{⊤} \frac{d {\hat{θ}}_{- j , ϵ}}{dϵ} ‖}_{ϵ = 0} = - {∇}_{θ} {\hat{l} ( {z}_{test} )}^{⊤} {H}_{θ}^{- 1} l ( {x}_{j} , {y}_{j} , θ )$$

As shown in FIG. 3, at step 312, process 300 may include performing an action on the GNN based on the measure of influence. For example, GNN influence system 102 may detect an anomaly in the GNN based on the measure of influence of the target node on the GNN. In some non-limiting embodiments or aspects, GNN influence system 102 may detect the anomaly in the GNN based on the measure of influence of the target node on the GNN by determining a measure of fairness for the GNN based on the measure of influence of the target node on the GNN. In some non-limiting embodiments or aspects, GNN influence system 102 may detect the anomaly in the GNN based on the measure of influence of the target node on the GNN by detecting that the measure of fairness for the GNN satisfies a threshold value (e.g., a predetermined threshold). Some non-limiting embodiments or aspects are described herein in connection with thresholds (e.g., a predetermined threshold). As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

In some non-limiting embodiments or aspects, GNN influence system 102 may detect an anomaly based on adversarial graph defense. In some non-limiting embodiments or aspects, GNN influence system 102 may detect an anomaly based on the graph topology of the graph. For example, GNN influence system 102 may detect an anomaly based on corruption or label noise associated with the topology of the graph.

In some non-limiting embodiments or aspects, GNN influence system 102 may refine the dataset based on the measure of fairness for the GNN. For example, GNN influence system 102 may reweight node data associated with the target node or reweight edge data associated with the target node based on the measure of fairness for the GNN to improve performance of the GNN.

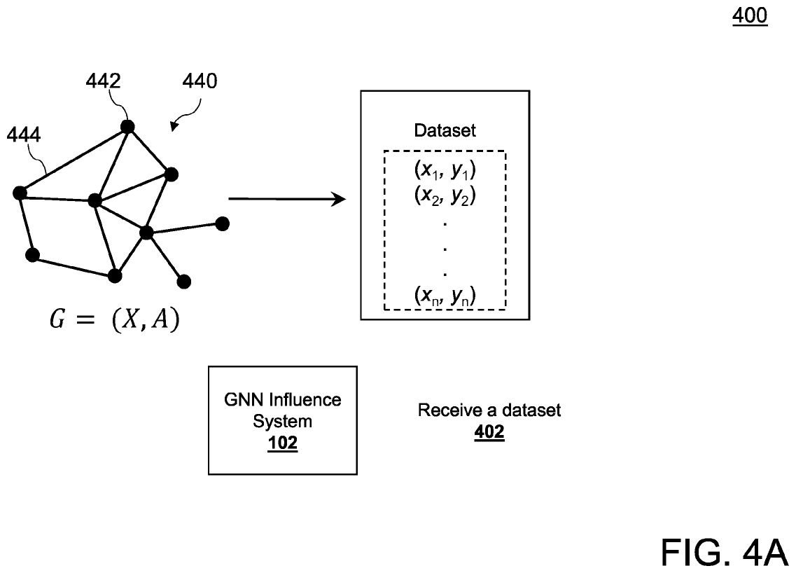

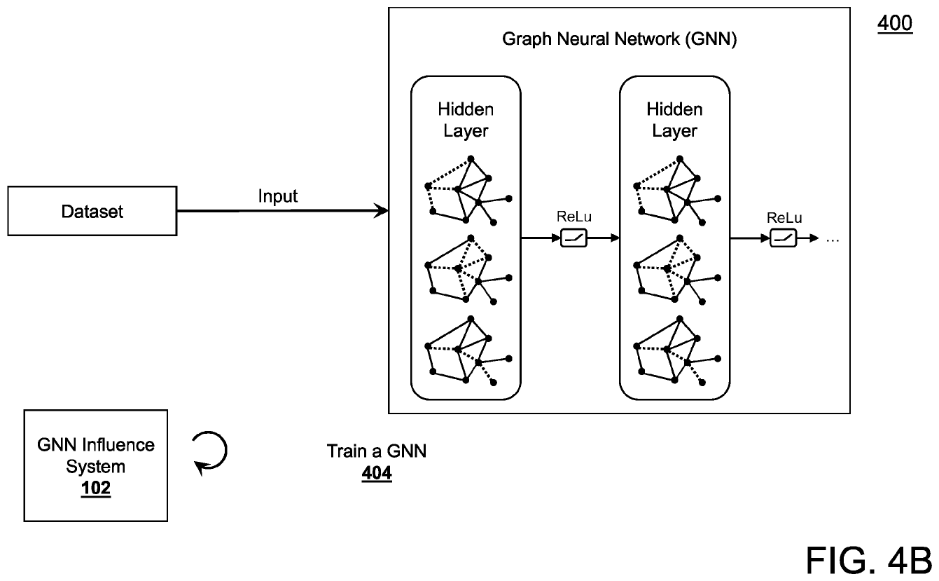

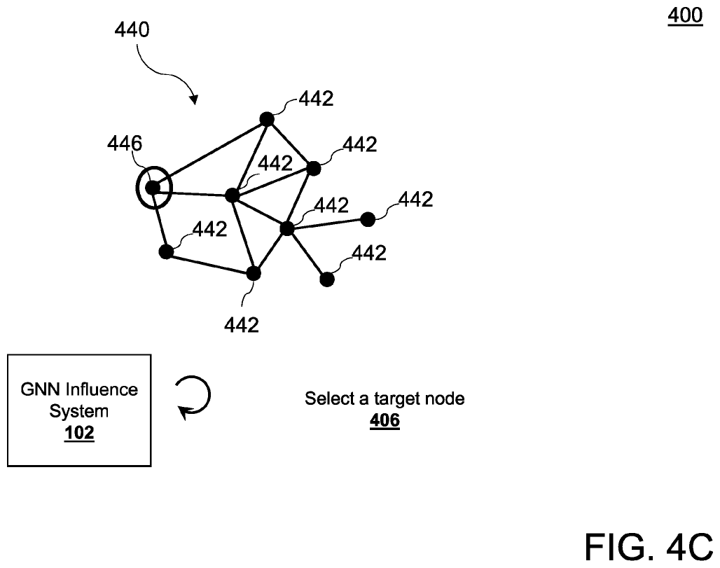

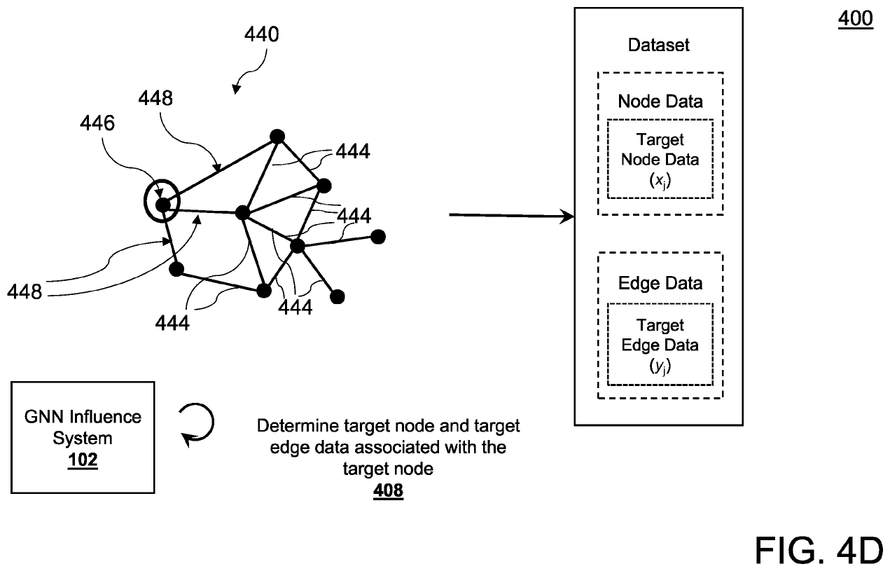

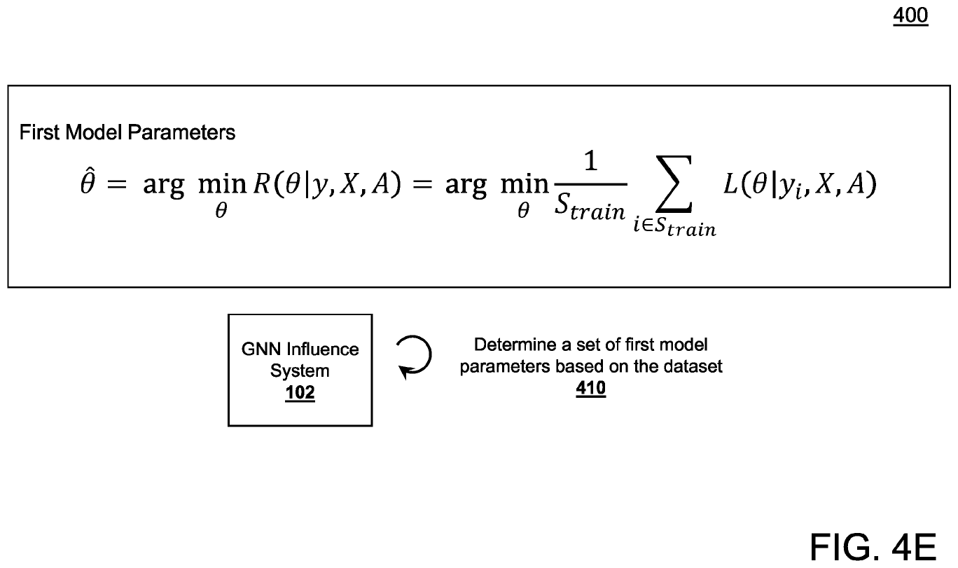

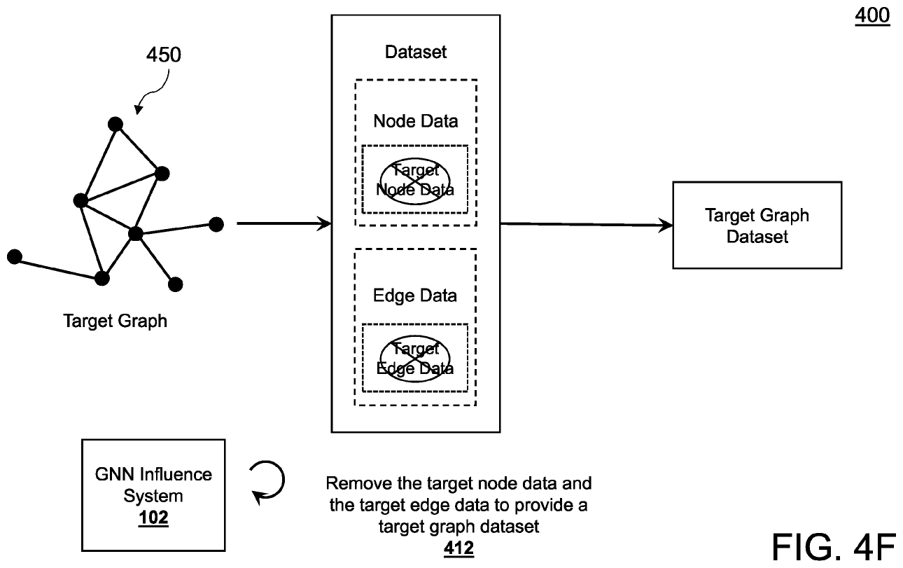

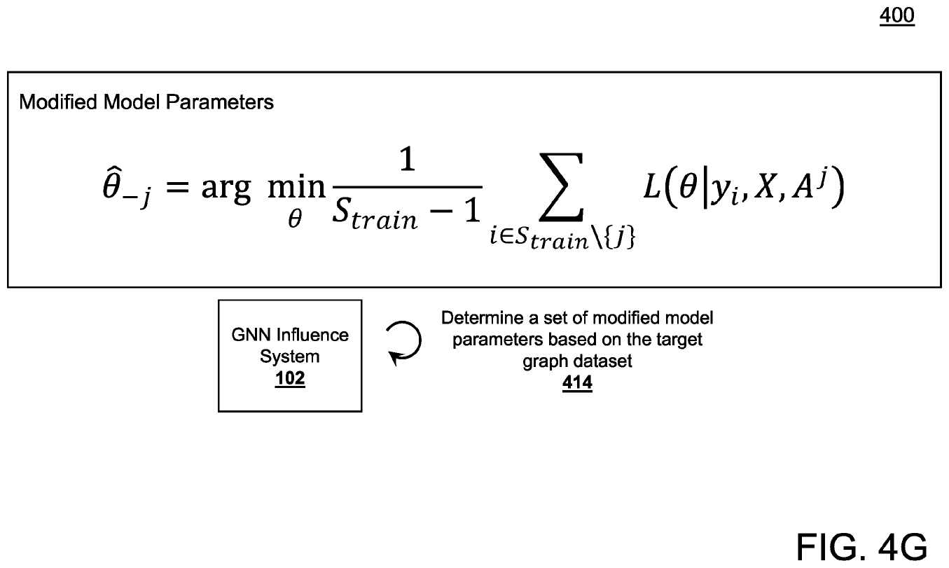

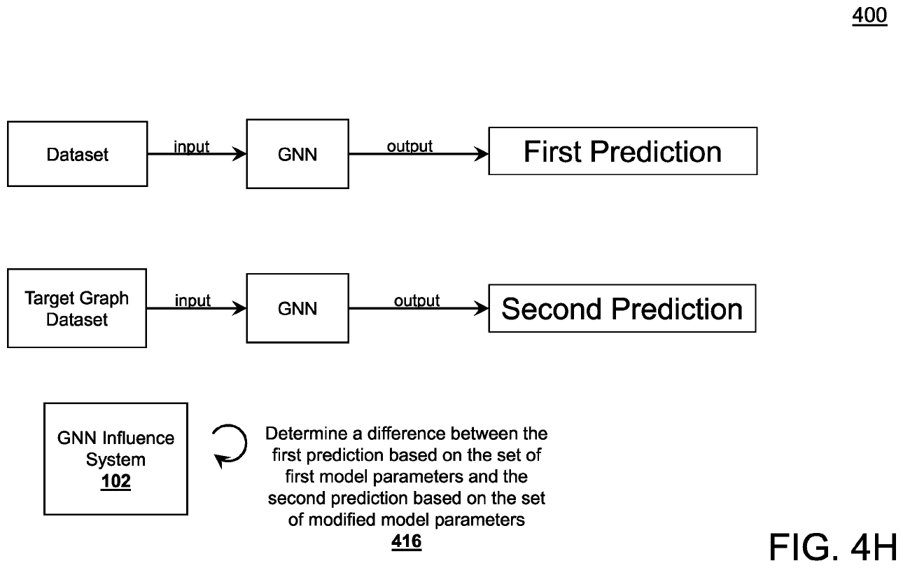

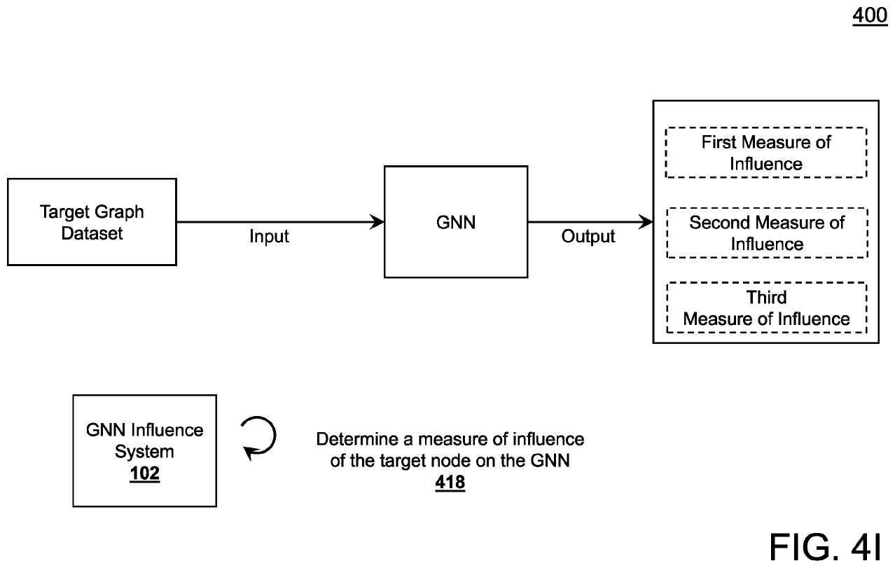

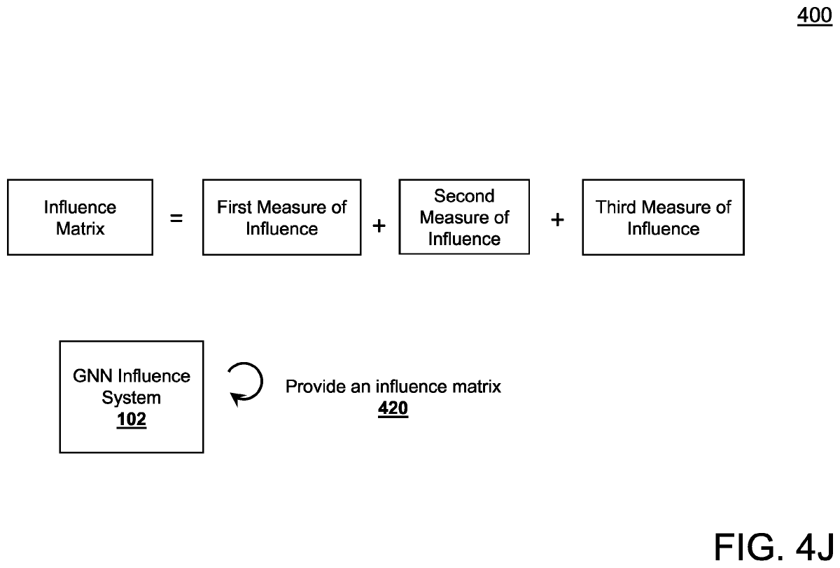

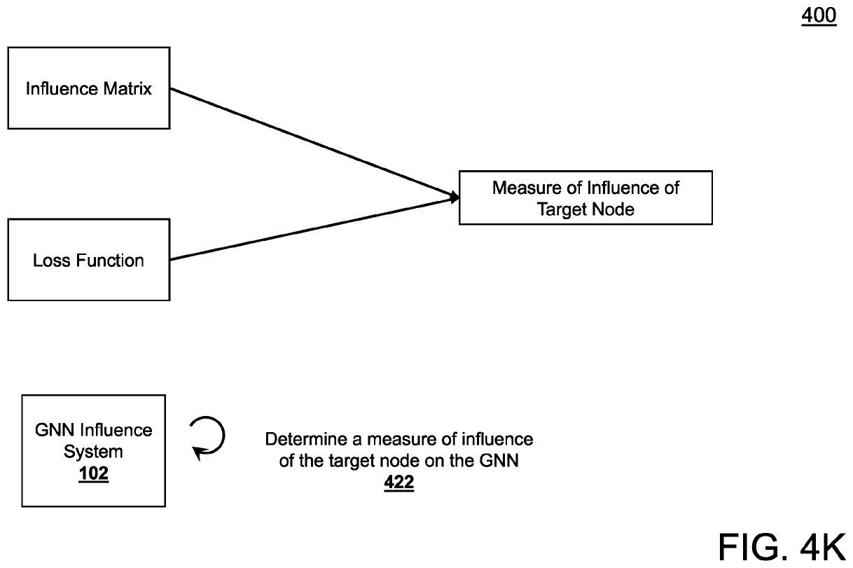

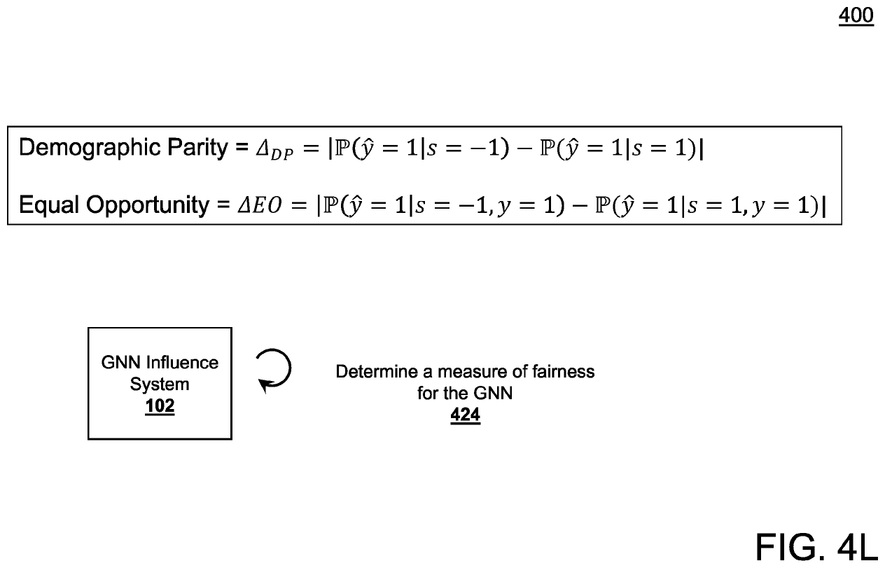

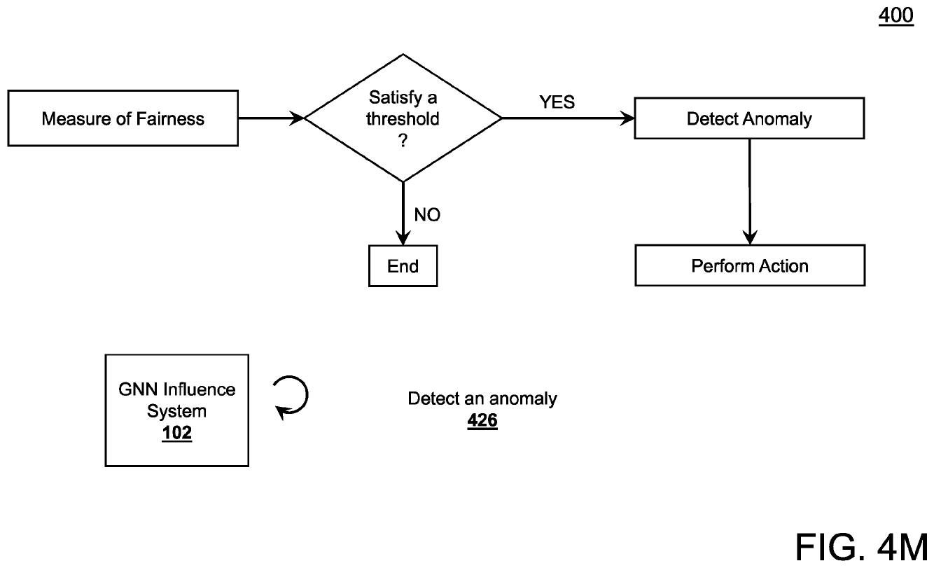

Referring now to FIGS. 4A-4M, FIGS. 4A-4M are diagrams of non-limiting embodiments or aspects of an implementation of a process 400 (e.g., process 300) for determining influence of a node of a graph on a GNN. As illustrated in FIGS. 4A-4M, implementation 400 may include GNN influence system 102 performing steps of a process (e.g., a process that is the same as or similar to process 300). In some non-limiting embodiments or aspects, one or more steps of process 400 may be performed (e.g., completely, partially, etc.) by another device or a group of devices separate from or including GNN influence system 102 (e.g., one or more devices of GNN influence system 102), such as transactions service provider system 104 (e.g., one or more devices of transaction service provider system 104) and/or user device 106.

As shown by reference number 402 in FIG. 4A, GNN influence system 102 may receive a dataset. For example, GNN influence system 102 may receive a dataset including graph data G=(X,A) associated with graph 440, where X represents a plurality of node features, and A represents a graph topology.

In some non-limiting embodiments or aspects, the graph data may include label y, where y is a ground truth label X∈ [symbol] ^{nxd} A∈{0,1}^{nxn}, where n represents a number of nodes and where d represents a dimension of an input feature. The graph data may alone include a training dataset Sₜᵣₐᵢₙ and/or a testing dataset Sₜₑₛₜ. In some non-limiting embodiments or aspects, training dataset Sₜᵣₐᵢₙ may include sample j and/or target nodes associated with sample j. In some non-limiting embodiments or aspects, testing dataset Sₜₑₛₜ may include test node t.

In some non-limiting embodiments or aspects, graph 440 may include a plurality of nodes 442 and/or a plurality of edges 444. Each edge 444 of the plurality of edges may connect node 442 of the plurality of nodes with another node 442 of the plurality of nodes.

The graph data associated with graph 440 may include node data (e.g., x₁, x₂, . . . xₙ) associated with the plurality of nodes of graph 440 and/or edge data (e.g., y₁, y₂, . . . yₙ) associated with the plurality of edges of graph 440.

As shown by reference number 404 in FIG. 4B, GNN influence system 102 may train a GNN. For example, GNN influence system 102 may train an initial GNN based on the dataset (e.g., a training dataset Sₜᵣₐᵢₙ) to provide the GNN. In some non-limiting embodiments or aspects, training the initial GNN may include generating the initial GNN, training the initial GNN based on a training dataset Sₜᵣₐᵢₙ, and/or re-training the initial GNN based on the training dataset Sₜᵣₐᵢₙ. In some non-limiting embodiments or aspects, the GNN may include an input layer, one or more hidden layers, and/or an output layer (not shown). In some non-limiting embodiments or aspects, the GNN may integrate features of the plurality of nodes and/or a topological structure of graph 440.

In some non-limiting embodiments or aspects, the GNN may be trained to perform one or more tasks. For example, the GNN may be trained to classify a node of the plurality of nodes. In some non-limiting embodiments or aspects, the GNN may provide enhanced fairness in node classifications.

In some non-limiting embodiments or aspects, the GNN may be trained by a process of leave one out (LOO) training, where one sample is removed from the dataset Sₜᵣₐᵢₙ.

In some non-limiting embodiments or aspects, an empirical risk minimization (ERM) may be used to train the GNN.

As shown by reference number 406 in FIG. 4C, GNN influence system 102 may select a target node. For example, GNN influence system 102 may select target node 446 from the plurality of nodes 442 of graph 440. In some non-limiting embodiments or aspects, target node 446 may be associated with a sample j. In some non-limiting embodiments or aspects, target node 446 may be a test node t.

As shown in FIG. 4D, target node 446 may be associated with one or more target edge(s) 448 of the plurality of edges 444. In some non-limiting embodiments or aspects, the one or more target edge(s) 448 may include one or more edges connected to target node 446 in graph 440. In some non-limiting embodiments or aspects, target node 446 may connect with one or more other nodes of the plurality of nodes 442 via target edge(s) 448.

As shown by reference number 408 in FIG. 4D, GNN influence system 102 may determine target node data and target edge data associated with the target node. For example, GNN influence system 102 may determine target node data (e.g., xᵢ) associated with target node 446 and target edge data (e.g., yᵢ) associated with target node 446 and/or target edge(s) 448 based on the graph data.

As shown by reference number 410 in FIG. 4E, GNN influence system 102 may determine a set of first model parameters based on the dataset. For example, GNN influence system 102 may determine a set of first model parameters for the GNN based on the dataset.

In some non-limiting embodiments or aspects, the GNN may be a predictive model with parameters θϵθ mapping input X∈X to output space Ŷ∈Y. The dataset may include training data samples {(x₁,y₁), (x₂,y₂) . . . (xₙ,yₙ)}, where n represents the number of training data samples.

In some non-limiting embodiments or aspects, the GNN may include a loss function, l(x, y, θ) that may be twice-differentiable and convex in 0. In some non-limiting embodiments or aspects, an ERM may be used to train the model parameters. The loss function for node classification may depend on the plurality of node features X, graph topology A, and/or ground truth tables y. In some non-limiting embodiments or aspects, the loss function for node i may be defined by the following equation, where l( . , . ) represents a cross-entropy loss function and GNNᵢ(θ, X, A) represents the prediction for i-th node given the graph data:

L(θ|X,A,yᵢ)=l(GNNᵢ(θ,X,A),yᵢ)

In some non-limiting embodiments or aspects, the set of first model parameters may be determined based on the following equation:

$$\hat{θ} = arg {min}_{θ} R ( θ \vert y , X , A ) = arg {min}_{θ} \frac{1}{{S}_{train}} {\sum }_{i ∈ {S}_{train}} L ( θ \vert {y}_{i} , X , A )$$

As shown by reference number 412 in FIG. 4F, GNN influence system 102 may remove the target node data and the target edge data to provide a target graph dataset. For example, GNN influence system 102 may remove target node data xᵢ associated with target node 446 and target edge data yᵢ associated with target edge(s) 448 from the dataset to provide the target graph dataset. The target graph dataset may include the dataset with the target node data xᵢ and the target edge data yᵢ removed.

In some non-limiting embodiments or aspects, when removing the target node data and/or the target edge data from the dataset, GNN influence system 102 may remove target node 446 and/or target edge(s) 448 from graph 440 to provide target graph 450.

As shown by reference number 414 in FIG. 4G, GNN influence system 102 may determine a set of modified model parameters based on the target graph dataset. For example, GNN influence system 102 may determine a set of modified model parameters for the GNN based on the target graph dataset.

In some non-limiting embodiments or aspects, the first set of model parameters may change based on removing the node topology for the target node (e.g., node j∈Sₜᵣₐᵢₙ) from the training dataset Sₜᵣₐᵢₙ and/or the loss contribution.

In some non-limiting embodiments or aspects, GNN influence system 102 may determine the set of modified model parameters based on the following equation, where j represents the sample associated with the target node, and where \hat{θ}₋ⱼ represents the model parameters for the target graph dataset, and where A^{j} represents an influence matrix after removing all edges connected to the target node:

$${\hat{θ}}_{- j} = arg {min}_{θ} \frac{1}{{S}_{train} - 1} {\sum }_{i ∈ {S}_{train} \backslash \{ j \}} L ( θ \vert {y}_{i} , X , {A}^{j} )$$

In some non-limiting embodiments or aspects, a test loss function for test node t may be defined by the following equation:

\hat{L}(θ₋ⱼ|X,A,yₜ)

In some non-limiting embodiments or aspects, in a case where the node topology and the loss contribution for node j∈Sₜᵣₐᵢₙ has been removed from the training dataset Sₜᵣₐᵢₙ, GNN influence system 102 may predict test node t∈Sₜₑₛₜ using the test loss function based on the following:

\hat{L}(\hat{θ}₋ⱼ|X,A^{j},yₜ)−\hat{L}(\hat{θ}₋ⱼ|X,A,yₜ)

As shown by reference number 416 in FIG. 4H, GNN influence system 102 may determine a difference between the first prediction based on the set of first model parameters and the second prediction based on the set of modified model parameters.

In some non-limiting embodiments or aspects, GNN influence system 102 may determine a first prediction based on inputting the dataset into the GNN and receiving the first prediction as a first output of the GNN.

In some non-limiting embodiments or aspects, GNN influence system 102 may determine a second prediction based on inputting the target graph dataset into the GNN and receiving the second prediction as a second output of the GNN.

In some non-limiting embodiments or aspects, GNN influence system 102 may determine modified model parameters by providing a continuous change for node topology and loss contribution via perturbation of the node topology and upweighting the loss function for sample j by n and E, respectively. For example, the modified model parameters with perturbation of n and E for target node j may be based on the following equation:

$${\hat{θ}}_{- j , n , ∈} = arg {min}_{θ} \frac{1}{{S}_{train}} {\sum }_{i ∈ {S}_{train}} L ( θ \vert {y}_{i} , X , {A}^{j , n} ) + ∈ L ( θ \vert {y}_{i} , X , {A}^{j , n} )$$

In some non-limiting embodiments or aspects, the modified adjacency matrix for a number of rows m and a number of columns n may be based on the following:

$${A}_{mn}^{n , j} = \{ \begin{matrix}( 1 - n ) {A}_{mn} , & if m = j or n = j ; \\ {A}_{mn} , & otherwise\end{matrix}$$

As shown by reference number 418 in FIG. 4I, GNN influence system 102 may determine a measure of influence of the target node on the GNN. For example, GNN influence system 102 may determine the measure of influence of target node 446 on the GNN based on the target graph dataset, where the GNN was trained using the dataset (e.g., before removing the target node data and/or the target edge data).

In some non-limiting embodiments or aspects, the measure of influence of the target node may be traced in forward and/or backward propagation through gradient access with respect to the topology of target graph 450 and the parameters of the GNN. For example, the measure of influence of the target nodes may include a node topology influence of the target node during forward propagation and/or a node prediction contribution for a training loss during backward propagation. In some non-limiting embodiments or aspects, a closed-form solution may be derived to approximate the measure of influence of the target node.

In some non-limiting embodiments or aspects, GNN influence system 102 may determine a first measure of influence, a second measure of influence, and/or a third measure of influence.

In some non-limiting embodiments or aspects, the first measure of influence may be associated with properties of target node 446 with regard to a topology of graph 440. In some non-limiting embodiments or aspects, determining the first measure of influence of target node 446 on the GNN may include determining the first measure of influence on target node 446 on the GNN based on a Hessian matrix.

In some non-limiting embodiments or aspects, the measure of influence may include: the first measure of influence; the second measure of influence; and/or the third measure of influence. The first measure of influence may be based on topology influence (TI), which represents the effect of only removing node topology of the target node (e.g., sample j). The second measure of influence may be based on loss weight influence (LWI), which represents the effect of simultaneously removing the node topology of the target node and the loss weight. The third measure of influence may be based on the interaction influence (II). TI may measure the influence of topology for target node 446 in forward propagation. LWI may represent an original influence function in the dataset. II may occur during removing both topology and prediction contribution in the loss function.

In some non-limiting embodiments or aspects, the first measure of influence may be associated with properties of target node 446 with regard to a topology of graph 440. In some non-limiting embodiments or aspects, determining the first measure of influence of target node 446 on the GNN may include determining the first measure of influence on target node 446 on the GNN based on a Hessian matrix.

In some non-limiting embodiments or aspects, the second measure of influence may be associated with one or more features of target node 446. In some non-limiting embodiments or aspects, determining the second measure of influence of target node 446 on the GNN may include determining the second measure of influence on target node 446 on the GNN based on a Hessian matrix.

In some non-limiting embodiments or aspects, the third measure of influence may be associated with the target graph dataset. In some non-limiting embodiments or aspects, determining the third measure of influence of target node 446 on the GNN may include determining the third measure of influence on target node 446 on the GNN based on a Hessian matrix.

In some non-limiting embodiments or aspects, based on the modified model parameters \hat{θ}_{-j,n,∈}, an optimal model parameter difference with perturbation of the node topology by n and upweighting the loss function by ∈ for node j, defined as \hat{θ}_{-j,n,∈}=\hat{θ}_{-j,n,∈}−\hat{θ} may be based on the following equation, where

$${Δ}_{- j}^{⊤ I} n$$

represents the topology influence, where

$${Δ}_{- j}^{LWI} ∈$$

represents the weight influence, and where

$${Δ}_{- j}^{II} n ∈$$

represents the interaction influence:

$${Δ}_{- j , n , ∈} ≅ {Δ}_{- j}^{⊤ I} n + {Δ}_{- j}^{LWI} ∈ + {Δ}_{- j}^{II} n ∈$$

In some non-limiting embodiments or aspects, a Hessian matrix, He, may be a square matrix of second-order partial derivatives of a scalar-valued function which describes the local of the scalar-valued function. In some non-limiting embodiments or aspects, the Hessian matrix may be positive definite. In some non-limiting embodiments or aspects, a Hessian matrix may be determined based on the following equation:

$${H}_{θ} = \frac{1}{n} {\sum }_{i = 1}^{n} {∇}_{θ}^{2} R ( θ \vert ( {x}_{i} , {y}_{i} ) , iϵ [ n ] )$$

In some non-limiting embodiments or aspects, GNN influence system 102 may use a stochastic estimation to estimate the influence of the target node on the GNN. For example, GNN influence system 102 may determine a one order Taylor's expansion of a Hessian matrix based on the following equation:

$$\frac{{\hat{θ}}_{ϵ , z}}{d ∈} {\vert}_{∈ = 0} = - {H}_{\hat{θ}}^{- 1} {∇}_{θ} L ( z , \hat{θ} )$$

In some non-limiting embodiments or aspects, GNN influence system 102 may replace a Hessian matrix with a gradient based on the following:

$$H ( x ) v \approx \frac{g ( x + rv ) - g ( x )}{r}$$

In some non-limiting embodiments or aspects, GNN influence system 102 may approximate an inverse of a Hessian matrix

$${H}_{θ}^{- 1}$$

based on the following equation:

$${H}_{θ}^{- 1} = {∇}_{θ}^{2} R ( \hat{θ} \vert y , X , A )$$

In some non-limiting embodiments or aspects, GNN influence system 102 may determine the first influence (e.g., the topology influence

$${Δ}_{- j}^{⊤ I} n )$$

based on the following equation:

$${Δ}_{- j}^{⊤ I} n = {H}_{θ}^{- 1} {∇}_{n , j} {∇}_{θ} R ( \hat{θ} \vert y , X , A )$$

In some non-limiting embodiments or aspects, GNN influence system 102 may determine the second influence

$$( e . g . , the weight influence {Δ}_{- j}^{L W 1} ∈ )$$

based on the following equation:

$${Δ}_{- j}^{LWI} ∈ = {H}_{θ}^{- 1} {∇}_{θ} L ( \hat{θ} \vert {y}_{i} , X , A )$$

In some non-limiting embodiments or aspects, GNN influence system 102 may determine the third influence

$$( e . g . , the interaction influence {Δ}_{- j}^{II} n ∈ )$$

based on the following equation:

$${Δ}_{- j}^{II} n ∈ = {H}_{θ}^{- 1} {∇}_{n , j} {∇}_{θ} L ( \hat{θ} \vert {y}_{i} , X , A )$$

In some non-limiting embodiments or aspects, simultaneously removing the node topology and loss weight may be the same as or similar to upweighting the sample j by n=1 and perturbing the sample j by

$$∈ = \frac{- 1}{\vert {S}_{train} \vert} .$$

In some non-limiting embodiments or aspects, the parameter change may linearly approximated without retraining the model based on the following equation:

$${Δ}_{- {j}_{,} n , ∈} ≅ {Δ}_{- j}^{⊤ I} - \frac{1}{\vert {S}_{train} \vert} {Δ}_{- j}^{LWI} - \frac{1}{\vert {S}_{train} \vert} {Δ}_{- j}^{II}$$

In some non-limiting embodiments or aspects, given the model parameters perturbation, GNN influence system 102 may determine a difference between the first prediction based on the set of first model parameters and the second prediction based on the set of modified model parameters for test node t∈Sₜₑₛₜ based on the loss function, \hat{L}(\hat{θ}₋ⱼ|X,A^{j},yₜ), for test node t.

In some non-limiting embodiments or aspects, GNN influence system 102 may determine a model prediction change for test node t via the chain rule based on the following equation:

\hat{L}(\hat{θ}₋ⱼ|X,A^{j},yₜ)−\hat{L}(\hat{θ}₋ⱼ|X,A,yₜ)=−∇\hat{L}\hat{L}(\hat{θ}₋ⱼ|X,A^{j},yₜ)^{T}Δ_{-j,n∈}

As shown by reference number 420 in FIG. 4J, GNN influence system 102 may provide an influence matrix. For example, GNN influence system 102 may combine (e.g., adding, concatenating, averaging, etc.) the first measure of influence, the second measure of influence, and/or the third measure of influence to provide an influence matrix.

In some non-limiting embodiments or aspects, the influence matrix may be based on the following equation, where a gradient with regard to the node topology i∈Sₜᵣₐᵢₙ may be separated by setting nⱼ=0 for j∈Sₜᵣₐᵢₙ{i}:

$${A}_{mn}^{n} = \{ \begin{matrix}( 1 - {\sum }_{i ∈ {S}_{train}} {n}_{i} ) {A}_{mn} , & if m ∈ {S}_{train} or n ∈ {S}_{train} ; \\ {A}_{mn} , & otherwise\end{matrix}$$

As shown by reference number 422 in FIG. 4K, GNN influence system 102 may determine a measure of influence of the target node on the GNN. For example, GNN influence system 102 may determine a measure of influence of the target node on the GNN based on the influence matrix and the loss function.

As shown by reference number 424 in FIG. 4L, GNN influence system 102 may determine a measure of fairness for the GNN. For example, GNN influence system 102 may determine a measure of fairness for the GNN based on a demographic parity and/or an equal opportunity.

In some non-limiting embodiments or aspects, the demographic parity Δ_{EO} may be determined based on the following equation, where y represents the ground truth label, and where ŷ represents the predicted label:

Δ_{DP}=|P(ŷ=1|s=−1)−P(ŷ=1|s=1)|

In some non-limiting embodiments or aspects, the equal opportunity Δ_{EO} may be determined based on the following equation, where y represents the ground truth label, and where ŷ represents the predicted label:

Δ_{EO}=|P(ŷ=1|s=−1,y=−1)−P(ŷ=−1|s=1,y=1)|

As shown by reference number 426 in FIG. 4M, GNN influence system 102 may detect an anomaly. For example, GNN influence system 102 may detect an anomaly in the GNN based on the measure of influence of the target node.

In some non-limiting embodiments or aspects, when detecting the anomaly in the GNN, GNN influence system 102 may determine the measure of fairness for the GNN based on the measure of influence of the target node on the GNN. In some non-limiting embodiments or aspects, when detecting the anomaly in the GNN, GNN influence system 102 may detect whether a value of the measure of fairness for the GNN satisfies a predetermined threshold value. For example, GNN influence system 102 may compare the value of the measure of fairness for the GNN to the predetermined threshold value to determine whether the value of the measure of fairness for the GNN satisfies the predetermined threshold value. If GNN influence system 102 determines that the measure of fairness for the GNN satisfies the predetermined threshold value, GNN influence system 102 may detect an anomaly and/or perform an action based on detecting the anomaly. If GNN influence system 102 determines that the measure of fairness for the GNN does not satisfy the predetermined threshold value, GNN influence system 102 may determine that an anomaly has not been detected and/or the process may end.

In some non-limiting embodiments or aspects, detecting an anomaly may include detecting fraud. For example, GNN influence system 102 may detect a fraudulent transaction based on the measure of fairness satisfying the predetermined threshold value. In some non-limiting embodiments or aspects, GNN influence system 102 may perform an action on the GNN based on detecting the anomaly, such as sending an alert, a notification, and/or the like.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

1. A computer-implemented method, comprising:
receiving, with at least one processor, a dataset comprising graph data associated with a graph, the graph data comprising node data associated with a plurality of nodes of the graph and edge data associated with a plurality of edges of the graph;
selecting, with at least one processor, a target node of the plurality of nodes based on the graph data;
determining, with at least one processor, target node data associated with the target node and target edge data associated with the target node based on the graph data, the node data of the graph data comprising the target node data and the edge data of the graph data comprising the target edge data, wherein the target node is associated with one or more target edges of the plurality of edges, the one or more target edges comprising one or more edges connected to the target node in the graph;
removing, with at least one processor, the target node data and the target edge data from the dataset to provide a target graph dataset, wherein the target graph dataset comprises the dataset with the target node data and the target edge data removed;
determining, with at least one processor, a measure of influence of the target node on a graph neural network (GNN) based on the target graph dataset, wherein the GNN was trained using the dataset; and
detecting, with the at least one processor, an anomaly in the GNN based on the measure of influence of the target node on the GNN.

2. The computer-implemented method of claim 1, further comprising:
training an initial GNN based on the dataset to provide the GNN.

3. The computer-implemented method of claim 1, wherein determining the measure of influence of the target node on the GNN based on the target graph dataset comprises:
determining a set of first model parameters for the GNN based on the dataset;
determining a set of modified model parameters for the GNN based on the target graph dataset; and
determining a difference between a first prediction of the GNN based on the set of first model parameters and a second prediction of the GNN based on the set of modified model parameters.

4. The computer-implemented method of claim 1, wherein determining the measure of influence of the target node on the GNN based on the target graph dataset comprises:
determining a first measure of influence of the target node on the GNN, wherein the first measure of influence is associated with properties of the target node with regard to topology of the graph;
determining a second measure of influence of the target node on the GNN, wherein the second measure of influence is associated with features of the target node;
determining a third measure of influence of the target node on the GNN, wherein the third measure of influence is associated with the target graph dataset;
combining the first measure of influence, the second measure of influence, and the third measure of influence to provide an influence matrix; and
determining the measure of influence of the target node on the GNN based on a loss function and the influence matrix.

5. The computer-implemented method of claim 4, wherein determining the first measure of influence of the target node on the GNN comprises determining the first measure of influence of the target node on the GNN based on a Hessian matrix.

6. The computer-implemented method of claim 4, wherein determining the second measure of influence of the target node on the GNN comprises determining the second measure of influence of the target node on the GNN based on a Hessian matrix.

7. The computer-implemented method of claim 4, wherein determining the third measure of influence of the target node on the GNN comprises determining the third measure of influence of the target node on the GNN based on a Hessian matrix.

8. The computer-implemented method of claim 1, wherein detecting the anomaly in the GNN based on the measure of influence of the target node on the GNN comprises:
determining a measure of fairness for the GNN based on the measure of influence of the target node on the GNN; and
detecting that the measure of fairness for the GNN satisfies a predetermined threshold.

9. The computer-implemented method of claim 1, wherein removing the target node data and the target edge data from the dataset comprises removing the target node and the one or more target edges from the graph.

10. A system comprising:
at least one processor programmed or configured to:
receive a dataset comprising graph data associated with a graph, the graph data comprising node data associated with a plurality of nodes of the graph and edge data associated with a plurality of edges of the graph;
select a target node of the plurality of nodes based on the graph data;
determine target node data associated with the target node and target edge data associated with the target node based on the graph data, the node data of the graph data comprising the target node data and the edge data of the graph data comprising the target edge data, wherein the target node is associated with one or more target edges of the plurality of edges, the one or more target edges comprising one or more edges connected to the target node in the graph;
remove the target node data and the target edge data from the dataset to provide a target graph dataset, wherein the target graph dataset comprises the dataset with the target node data and the target edge data removed;
determine a measure of influence of the target node on a graph neural network (GNN) based on the target graph dataset, wherein the GNN was trained using the dataset; and
detect an anomaly in the GNN based on the measure of influence of the target node on the GNN.

11. The system of claim 10, wherein the at least one processor is further programmed or configured to:
train an initial GNN based on the dataset to provide the GNN.

12. The system of claim 10, wherein, when determining the measure of influence of the target node on the GNN based on the target graph dataset, the at least one processor is programmed or configured to:
determine a set of first model parameters for the GNN based on the dataset;
determine a set of modified model parameters for the GNN based on the target graph dataset; and
determine a difference between a first prediction of the GNN based on the set of first model parameters and a second prediction of the GNN based on the set of modified model parameters.

13. The system of claim 10, wherein, when determining the measure of influence of the target node on the GNN based on the target graph dataset, the at least one processor is programmed or configured to:
determine a first measure of influence of the target node on the GNN, wherein the first measure of influence is associated with properties of the target node with regard to topology of the graph;
determine a second measure of influence of the target node on the GNN, wherein the second measure of influence is associated with features of the target node;
determine a third measure of influence of the target node on the GNN, wherein the third measure of influence is associated with the target graph dataset;
combine the first measure of influence, the second measure of influence, and the third measure of influence to provide an influence matrix; and
determine the measure of influence of the target node on the GNN based on a loss function and the influence matrix.

14. The system of claim 13, wherein, when determining the first measure of influence of the target node on the GNN, the at least one processor is programmed or configured to:
determine the first measure of influence of the target node on the GNN based on a Hessian matrix.

15. The system of claim 13, wherein, when determining the second measure of influence of the target node on the GNN, the at least one processor is programmed or configured to:
determine the second measure of influence of the target node on the GNN based on a Hessian matrix.

16. The system of claim 13, wherein, when determining the third measure of influence of the target node on the GNN, the at least one processor is programmed or configured to:
determine the third measure of influence of the target node on the GNN based on a Hessian matrix.

17. The system of claim 10, wherein, when detecting the anomaly in the GNN based on the measure of influence of the target node on the GNN, the at least one processor is programmed or configured to:
determine a measure of fairness for the GNN based on the measure of influence of the target node on the GNN; and
detect that the measure of fairness for the GNN satisfies a predetermined threshold.

18. The system of claim 10, wherein, when removing the target node data and the target edge data from the dataset, the at least one processor is programmed or configured to:
remove the target node and the one or more target edges from the graph.

19. A computer program product comprising at least one non-transitory computer-readable medium including one or more instructions that, when executed by at least one processor, cause the at least one processor to:
receive a dataset comprising graph data associated with a graph, the graph data comprising node data associated with a plurality of nodes of the graph and edge data associated with a plurality of edges of the graph;
select a target node of the plurality of nodes based on the graph data;
determine target node data associated with the target node and target edge data associated with the target node based on the graph data, the node data of the graph data comprising the target node data and the edge data of the graph data comprising the target edge data, wherein the target node is associated with one or more target edges of the plurality of edges, the one or more target edges comprising one or more edges connected to the target node in the graph;
remove the target node data and the target edge data from the dataset to provide a target graph dataset, wherein the target graph dataset comprises the dataset with the target node data and the target edge data removed;
determine a measure of influence of the target node on a graph neural network (GNN) based on the target graph dataset, wherein the GNN was trained using the dataset; and
detect an anomaly in the GNN based on the measure of influence of the target node on the GNN.

20. The computer program product of claim 19, wherein the one or more instructions further cause the at least one processor to:
train an initial GNN based on the dataset to provide the GNN.

21-27. (canceled)
